(19) United States
(12) Patent Application Publication
(10) Pub. No.: US 2015/0049879 A1
(43) Pub. Date: Feb. 19, 2015

(54) METHOD OF AUDIO PROCESSING AND AUDIO-PLAYING DEVICE

(71) Applicant: Kuo-Ping Yang, Taipei (TW)

(72) Inventors: Neo Bob Chih-Yung YOUNG, Taipei (TW); Pao-Chuan TORNG, Taipei (TW); Tzu-Chien TZENG, Taipei (TW); Vincent Shuang-Pung LIAW, Taipei (TW); Yun-Da HSIEH, Taipei (TW); Kuo-Ping YANG, Taipei (TW); Kuan-Li CHAO, Taipei (TW)

(21) Appl. No.: 14/166,095

(22) Filed: Jan. 28, 2014

(30) Foreign Application Priority Data
Aug. 14, 2013 (TW) 102129142

(51) Int. Cl. H04R 3/04

(52) U.S. Cl. CPC H04R 3/04
USPC 381/98

(57) ABSTRACT

A method of audio processing lowers the frequency of a high frequency audio area of an input audio in order to generate a lowered frequency audio area. The lowered frequency audio area is combined with the input audio to generate an output audio such that the output audio comprises the high frequency audio area, a low frequency audio area, and a lowered frequency audio area.

### BACKGROUND OF THE INVENTION

1. Field of the Invention

The present invention relates to a method of audio processing applied in an audio-playing device, such as a speaker, a speaker of a television, and so on.

2. Description of the Related Art

Generally, a speaker or a television is designed only for outputting audio, or audible content of media, for normal-hearing listeners. However, as people get older, their ability to hear high frequency sounds decreases gradually. Many people over the age of 70 years (who are mildly hearing-impaired listeners) can still clearly hear sounds at 8,000 Hz; however, they might not be able to hear sounds over 8,000 Hz. Most of the sounds of human languages are below 8,000 Hz; therefore, most people over the age of 70 years can function adequately in verbal communications. However, it is quite common that music or some television scenes have audio effects over 8,000 Hz, which most people over the age of 70 years cannot hear clearly. If the speaker or the television can lower the high frequency audio while outputting the audio, it can improve the audio quality for mildly hearing-impaired listeners; however, it may provide a poor audio quality for listeners without hearing impairment because the frequency of the high frequency audio is lowered.

Therefore, there is a need to provide a method of audio processing and an audio-playing device to improve the audio quality for hearing-impaired listeners while maintaining a good audio quality for listeners without hearing impairment so as to mitigate and/or obviate the aforementioned problems.

### SUMMARY OF THE INVENTION

It is an object of the present invention to provide a method of audio processing and an audio-playing device to allow normal-hearing listeners and mildly hearing-impaired listeners to listen to music or watch television together.

To achieve the abovementioned object, the method of audio processing of the present invention is used in an audio-playing device having an open speaker, the method comprising:

receiving an input audio, the input audio including a high frequency audio area and a low frequency audio area;

obtaining the high frequency audio area and performing a frequency lowering process in order to generate a lowered frequency audio area;

combining the lowered frequency audio area with the input audio to generate an output audio such that the output audio comprises the high frequency audio area, the low frequency audio area, and the lowered frequency audio area; and

outputting the output audio via the open speaker.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a hardware structural drawing of an audio-playing device according to the present invention.

FIG. 2 illustrates a flowchart of a method of audio processing according to the present invention.

FIG. 3 illustrates a schematic drawing of an input audio according to the present invention.

FIG. 4 illustrates a schematic drawing of a high frequency audio area according to the present invention.

FIG. 5 illustrates a schematic drawing of performing a frequency lowering process according to the present invention.

FIG. 6 illustrates a schematic drawing of an output audio according to the present invention.

FIG. 7 illustrates a schematic drawing of the output audio according to another embodiment of the present invention.

### DETAILED DESCRIPTION OF THE PREFERRED EMBODIMENT

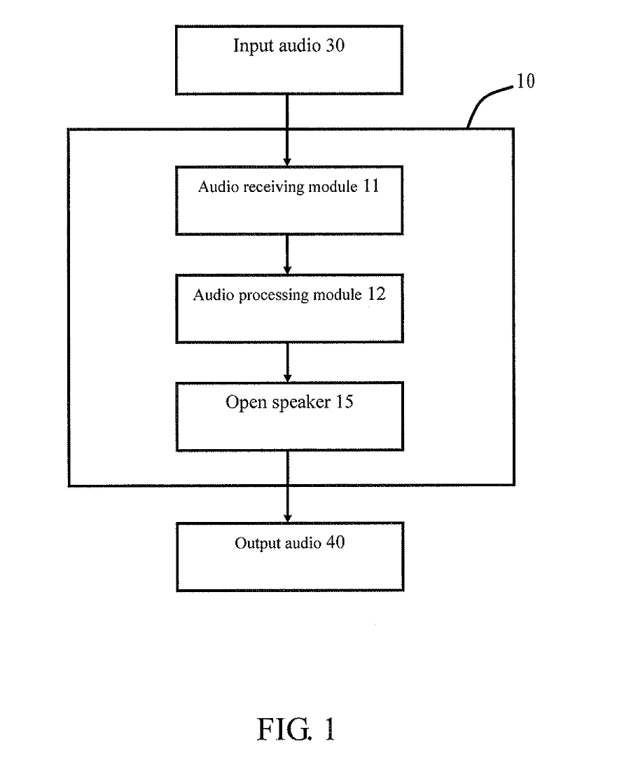

Please refer to FIG. 1, which illustrates a hardware structural drawing of an audio-playing device 10 according to the present invention. The audio-playing device 10 comprises an audio receiving module 11, an audio processing module 12, and an open speaker 15. The audio receiving module 11 is used for receiving an input audio 30. The audio processing module 12 is used for processing the input audio 30 in order to generate an output audio 40. The open speaker 15 is used for playing the output audio 40.

The audio-playing device 10 can be, for example, a speaker device. The input audio 30 can be, for example, an audio signal captured by a microphone, an audio signal transmitted by a radio station, MP3-formatted music transmitted from a MP3 player, an audio signal transmitted by a DVD player, and so on.

The audio receiving module 11 can be a wireless or a wired receiving module. The audio processing module 12 can be a hardware circuit, firmware, or these designs in combination with a software program (stored in a memory) and a processor. In a simpler design embodiment, it can be a computer-type structure, wherein the function of the audio receiving module 11 is accomplished by utilizing a processor to execute a software program.

The definition of the open speaker 15 is a speaker that plays the output audio 40 in the air, wherein the air is used as a medium, thereby allowing multiple listeners to hear the output audio 40 together without the need to wear earphones. The open speaker 15 includes a non-earphone speaker such as a general speaker or a television speaker.

The audio-playing device 10 can also be a television, a smart television, a mobile phone, a PAD, a computer capable of outputting audio, and the like, wherein the abovementioned device also includes an audio receiving module 11, an audio processing module 12, and an open speaker 15. The hardware structure of the audio-playing device 10 illustrated in FIG. 1 shows a basic structure for achieving the object of the present invention; therefore, the image processing and receiving modules of an audio-playing device 10 such as a television are not shown in FIG. 1.

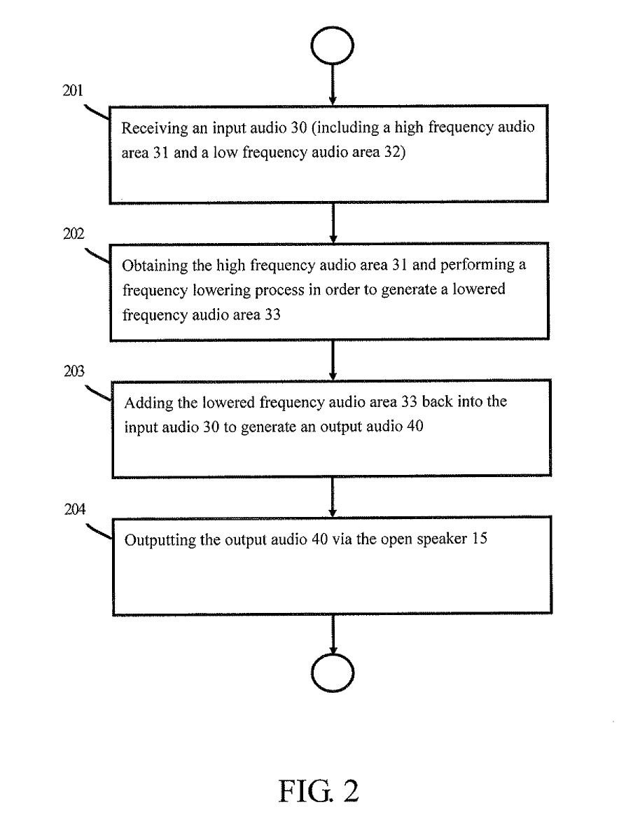

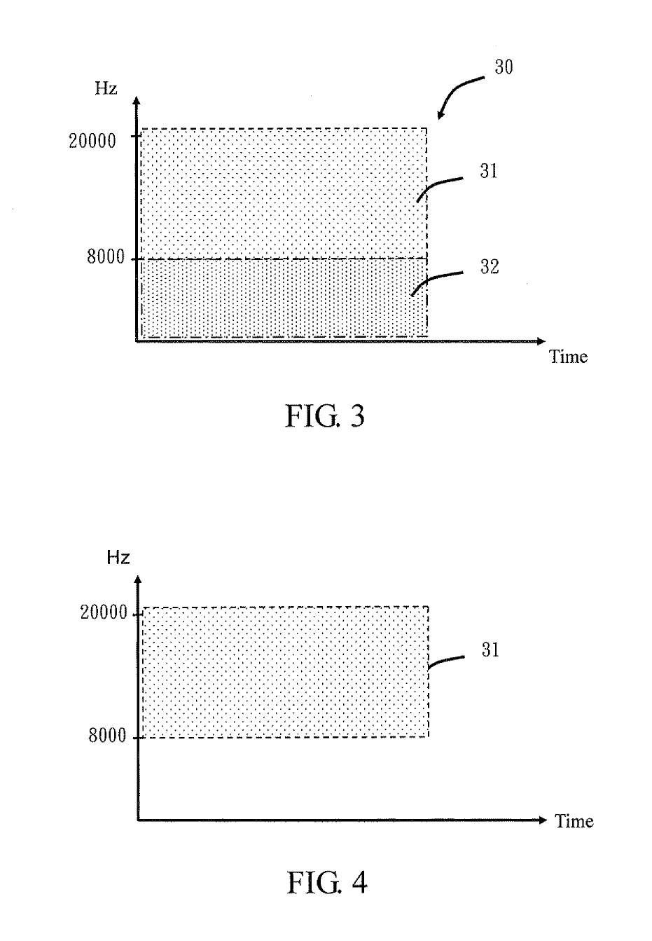

First, please refer to FIG. 2, which illustrates a flowchart of a method of audio processing according to the present invention. Please also refer to FIGS. 3˜7 illustrating schematic drawings related to audio.

Step 201: the audio receiving module 11 receives an input audio 30. As shown in FIG. 3, the input audio 30 includes a high frequency audio area 31 and a low frequency audio area 32. The range of human hearing is around 10 Hz to 20,000 Hz. Therefore, the audio between 10 Hz and 20,000 Hz is more meaningful to human ears. In this embodiment, the high frequency audio area 31 is, for example, between 8,000 Hz and 20,000 Hz; and the low frequency audio area 32 is, for example, between 0 Hz and 8,000 Hz. Most people over the age of 70 years can still clearly hear sounds at 8,000 Hz; however, they might not be able to hear sounds over 8,000 Hz (most people over the age of 70 years can hear sounds over 8,000 Hz only if they are over 40 dB (HL), because the higher frequency has to be at a higher volume to be heard). Most hearing-impaired listeners and older people have no problem with hearing low-frequency sounds; only high frequency sounds are inaudible to most hearing-impaired listeners. In addition, older people tend to have greater difficulty than younger people with hearing sounds at high frequencies.

Please note that the ranges of the high frequency audio area 31 and the low frequency audio area 32 are not fixed; the ranges can be adjusted and set by means such as being configured by a software program or a circuit design via a key, an operational button, or an on-screen instruction. Because the technique of setting the values is known by those with ordinary skill in the art, there is no need for further description. Basically, in the present invention, the input audio 30 is simply divided into two audio areas 31 and 32. For example, for one hearing-impaired listener, if the hearing-impaired listener can clearly hear only sounds below A Hz (for example, A is 4,000), then the method can use A Hz (such as 4,000 Hz) as a threshold for defining audio signals over A Hz (such as 4,000 Hz) as the high frequency audio area 31 and the audio signals below A Hz (such as 4,000 Hz) as the low frequency audio area 32.

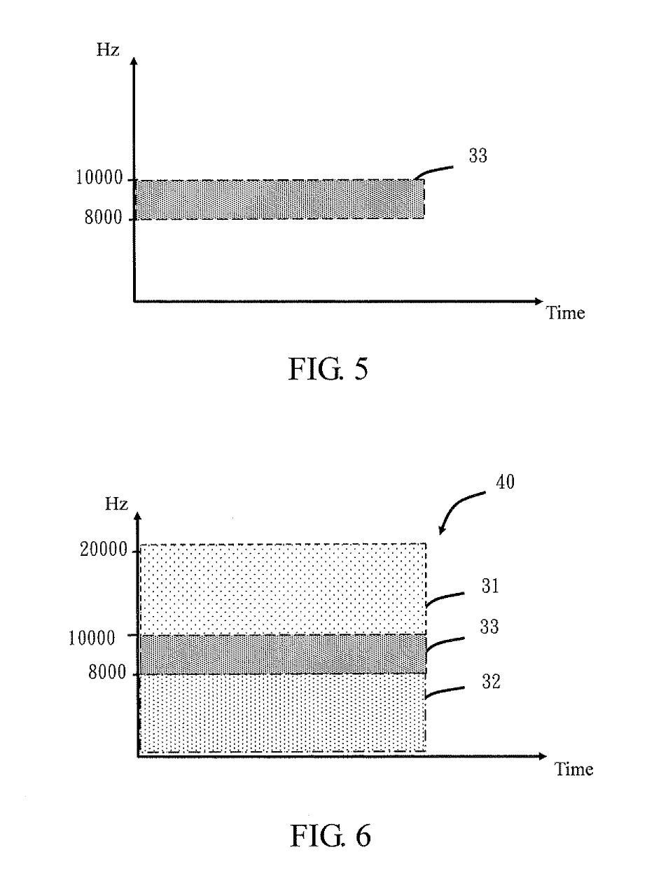

Step 202: the audio processing module 12 obtains the high frequency audio area 31 and performs a frequency lowering process in order to generate a lowered frequency audio area 33. As shown in FIG. 4, the audio processing module 12 can obtain the high frequency audio area 31 by means such as duplication. In addition, the frequency lowering process comprises a frequency compression process. Please refer to FIG. 5; for example, the original high frequency audio area 31 (8,000 Hz˜20,000 Hz) can be compressed into the lowered frequency audio area 33 (8,000 Hz 10,000 Hz).

Step 203: the audio processing module 12 combines the lowered frequency audio area 33 with the input audio 30 to generate an output audio 40. Please refer to FIG. 6; the output audio 40 comprises not only the original high frequency audio area 31 and the low frequency audio area 32 but also the lowered frequency audio area 33. According to the embodiment shown in FIG. 6, the lowered frequency audio area 33 overlaps with the high frequency audio area 31 in a comparatively lower frequency zone.

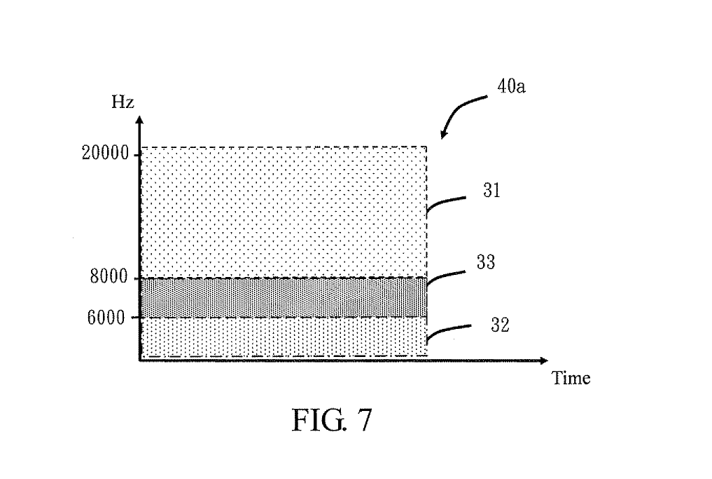

According to another embodiment for the output audio 40a, shown in FIG. 7, the audio processing module 12 further down-shifts the lowered frequency audio area 33 (by means of performing a frequency shifting process) such that the lowered frequency audio area 33 overlaps with the low frequency audio area 32 in a comparatively higher frequency zone. In the present invention, the best mode of performing the frequency lowering process should include the frequency compression process, but the mode does not necessarily include the frequency shifting process. The embodiment shown in FIG. 7 shows a lowered frequency audio area 33 that has been through both the frequency compression process and the frequency shifting process.

Please note that FIGS. 3-7 are all schematic drawings, wherein the process of processing the input audio 30 into the output audio 40 can be either a real-time process or a non-real-time process. If it is a real-time process, the input audio 30 (such as a song) is continuously inputted, wherein each process requires 0.001˜0.2 seconds, which means the above process will be performed 5˜1,000 times in 1 second. If it is a non-real-time process, the sampling frequency can be lower, such as the process being performed once every second or every 10 seconds.

In the present invention, there are some variables. The first variable is the division frequency (such as 8,000 Hz) for dividing the input audio 30 into two audio areas 31 and 32, and the second variable is that the frequency lowering process must be done with considerations of the frequency compression process and the frequency shifting process. The above variable values need to be changed according to the hearing capabilities of the hearing-impaired listener.

Step 204: outputting the output audio 40 via the open speaker 15. For purposes of illustration, please consider the television as an example of an audio-playing device 10. If a child (with normal hearing capability), an adult (with normal hearing capability), and an old person or a hearing-impaired listener (with poor hearing capability) are watching the television 10 together, the normal-hearing listeners can enjoy the original audio because the output audio 40 of the television 10 includes the original high frequency audio area 31 and the low frequency audio area 32. Of course, the normal-hearing listeners can also hear the lowered frequency audio area 33, but under most conditions, as confirmed through experiments, the normal-hearing listeners will hardly notice the existence of the lowered frequency audio area 33 because the tone of the lowered frequency audio area 33 is similar to that of the high frequency audio area 31. That is, the audio quality resulting from the combination of the lowered frequency audio area 33 and the input audio 30 is still acceptable to most normal-hearing listeners. With regard to the old people or the hearing-impaired listeners, who cannot hear the original high frequency audio area 31 (such as a high-pitched bell-ringing sound in music), the old people or the hearing-impaired listeners can enjoy a better audio quality because the information in the high frequency audio area 31 is presented in the lowered frequency audio area 33.

Please note that the high frequency audio area 31 and the lowered frequency audio area 33 are presented as examples and are not intended to limit the scope of the present invention. In practice, it is likely to be more meaningful that the high frequency audio area 31 includes audio at least over 2,500 Hz because most mildly hearing-impaired listeners have no problem hearing sounds below 2,500 Hz; moreover, human speech sounds below 2,500 Hz are usually vowels and overtones that are not suitable for frequency compression and frequency shifting processes. Furthermore, it is more meaningful that the processed lowered frequency audio area 33 includes audio at least below 16,000 Hz; otherwise, there is no need for utilizing the present invention because most people cannot easily tell whether or not sounds over 16,000 Hz exist in speech and music. Although the present invention has been explained in relation to its preferred embodiments, it is to be understood that many other possible modifications and variations can be made without departing from the spirit and scope of the invention as hereinafter claimed.

What is claimed is:

1. A method of audio processing, used in an audio-playing device, the audio-playing device including an open speaker, the method comprising:
receiving an input audio, the input audio including a high frequency audio area and a low frequency audio area;
obtaining the high frequency audio area and performing a frequency lowering process in order to generate a lowered frequency audio area;
combining the lowered frequency audio area with the input audio to generate an output audio such that the output audio comprises the high frequency audio area, the low frequency audio area, and the lowered frequency audio area; and
outputting the output audio via the open speaker.

2. The method of audio processing as claimed in claim 1, wherein the frequency lowering process comprises a frequency compression process.

3. The method of audio processing as claimed in claim 2, wherein the frequency lowering process further comprises a frequency shifting process.

4. The method of audio processing as claimed in claim 3, wherein in the output audio, a portion or all of the lowered frequency audio area overlaps with the low frequency audio area.

5. The method of audio processing as claimed in claim 1, wherein the high frequency audio area includes audio at least over 2,500 Hz.

6. The method of audio processing as claimed in claim 5, wherein the lowered frequency audio area includes audio at least less than 16,000 Hz.

7. The method of audio process as claimed in claim 1, wherein the audio-playing device is a television or a speaker device.

8. The method of audio process as claimed in claim 2, wherein the audio-playing device is a television or a speaker device.

9. The method of audio process as claimed in claim 3, wherein the audio-playing device is a television or a speaker device.

10. The method of audio process as claimed in claim 4, wherein the audio-playing device is a television or a speaker device.

11. An audio-playing device, comprising:
an audio receiving module, used for receiving an input audio, the input audio including a high frequency audio area and a low frequency audio area;
an audio processing module, for obtaining the high frequency audio area and performing a frequency lowering process in order to generate a lowered frequency audio area, and for combining the lowered frequency audio area with the input audio to generate an output audio such that the output audio comprises a high frequency audio area, a low frequency audio area, and a lowered frequency audio area
an open speaker, used for playing the output audio.

12. The audio-playing device as claimed in claim 11, wherein the frequency lowering process comprises a frequency compression process.

13. The audio-playing device as claimed in claim 12, wherein the frequency lowering process further comprises a frequency shifting process.

14. The audio-playing device as claimed in claim 13, wherein in the output audio, a portion or all of the lowered frequency audio area overlaps with the low frequency audio area.

15. The audio-playing device as claimed in claim 14, wherein the high frequency audio area includes audio at least over 2,500 Hz.

16. The audio-playing device as claimed in claim 15, wherein the lowered frequency audio area includes audio at least less than 16,000 Hz.

17. The audio-playing device as claimed in claim 11, wherein the audio-playing device is a television or a speaker device.

18. The audio-playing device as claimed in claim 12, wherein the audio-playing device is a television or a speaker device.

19. The audio-playing device as claimed in claim 13, wherein the audio-playing device is a television or a speaker device.

20. The audio-playing device as claimed in claim 14, wherein the audio-playing device is a television or a speaker device.
